(19) United States
(12) Patent Application Publication
(10) Pub. No.: US 2026/0029677 A1
(43) Pub. Date: Jan. 29, 2026

(54) LIQUID CRYSTAL PANEL AND THREE-DIMENSIONAL DISPLAY DEVICE

(71) Applicant: Sharp Display Technology Corporation, Kameyama City (JP)

(72) Inventors: Mitsuru CHIDA, Kameyama City (JP); Hiromi MATSUMOTO, Kameyama City (JP)

(21) Appl. No.: 19/273,601

(22) Filed: Jul. 18, 2025

(30) Foreign Application Priority Data
Jul. 24, 2024 (JP) 2024-118622

(51) Int. Cl. G02F 1/1339; G02F 1/1335

(52) U.S. Cl. CPC G02F 1/13394; G02F 1/133528

(57) ABSTRACT

A liquid crystal panel includes a display region, a frame region disposed around the display region, a first substrate, and a second substrate disposed facing the first substrate, in which a liquid crystal layer is disposed between the first substrate and the second substrate in the display region, a sealing portion is disposed between the first substrate and the second substrate in the frame region, the second substrate is provided with a protrusion protruding toward the liquid crystal layer side, and the first substrate includes a first support substrate and a first substrate-side insulating protrusion in order toward the liquid crystal layer side, the first substrate-side insulating protrusion being in contact with the first support substrate, protruding toward the liquid crystal layer side, facing the protrusion, and being formed in an island shape.

### CROSS-REFERENCE TO RELATED APPLICATIONS

This application claims the benefit of priority to Japanese Patent Application Number 2024-118622 filed on Jul. 24, 2024. The entire contents of the above-identified application are hereby incorporated by reference.

### BACKGROUND

### Technical Field

The disclosure described below relates to a liquid crystal panel and a three-dimensional display device provided with the liquid crystal panel.

An optical element such as a liquid crystal panel is used not only to display an image but also to compensate for a viewing angle or the like. As a technique related to a liquid crystal panel as an optical element, for example, JP H8-211395 A discloses a liquid crystal cell including a pair of electrode substrates combined via a belt-shaped seal and a liquid crystal that is sealed between the pair of electrode substrates by the seal, wherein a groove is formed on at least one of the inner surfaces of the pair of electrode substrates at a position facing the seal, and the pair of electrode substrates are combined with the seal located in the groove.

In addition, JP 2013-186148 A discloses a liquid crystal display device that includes a first substrate, a second substrate, a liquid crystal layer, a first spacer portion, and a second spacer portion. The first substrate has a first surface on which a plurality of transistors are formed, the first surface including a lattice-shaped light-blocking region and a plurality of opening regions each surrounded by the light-blocking region, and the light-blocking region including a plurality of first extending portions extending in a first direction and a plurality of second extending portions extending in a second direction intersecting the first direction. The second substrate has a second surface being disposed to face and spaced from the first surface. The liquid crystal layer is disposed between the first surface and the second surface. The first spacer portion has a longitudinal direction in the second direction, is formed on one of the first and second surfaces, is disposed at any one of a plurality of intersection positions obtained by the plurality of first extending portions and the plurality of second extending portions intersecting, and protrudes into the liquid crystal layer. The second spacer portion has a longitudinal direction in the first direction, is formed on the other of the first and second surfaces, is disposed to intersect the first spacer portion at an intersection position where the first spacer portion is disposed, and protrudes into the liquid crystal layer.

### SUMMARY

In recent years, three-dimensional display devices using liquid crystal panels have been developed. As one of three-dimensional display methods, there has been proposed a method in which, in a display device in which two liquid crystal panels are layered, an image for the left eye and an image for the right eye are alternately displayed on the liquid crystal panel on the back face side, polarization states of the respective images are controlled in the liquid crystal panel on the observation face side, and the images for the left eye and the right eye are separated and visually recognized by using polarized glasses. The liquid crystal panel on the observation face side functions as a so-called active retarder. As described above, a display device that delivers mutually different images for the left eye and right eye in a time-division manner to allow a depth sensation is also referred to as an active retarder type three-dimensional display device.

FIG. 17 is a photograph illustrating display unevenness of a display device according to a comparative embodiment. The display device of the comparative embodiment includes a display liquid crystal panel and a liquid crystal panel disposed on the observation face side of the display liquid crystal panel. The liquid crystal panel disposed on the observation face side is a liquid crystal panel in which an electrically controlled birefringence (ECB) mode liquid crystal layer is interposed between a pair of substrates, and functions as an active retarder.

In the display device of the comparative embodiment, as illustrated in FIG. 17, white unevenness occurs in a display region near a frame region (more specifically, a display region near a sealing portion).

In JP H8-211395 A and JP 2013-186148 A, a technique for curbing white unevenness in a display region near a frame region is not discussed.

The disclosure has been conceived in view of the above circumstances, and an object thereof is to provide a liquid crystal panel capable of curbing white unevenness in a display region near a frame region and a three-dimensional display device including the above liquid crystal panel.
(1) A liquid crystal panel according to an embodiment of the disclosure includes a display region, a frame region disposed around the display region, a first substrate, and a second substrate disposed facing the first substrate, in which a liquid crystal layer is disposed between the first substrate and the second substrate in the display region, a sealing portion is disposed between the first substrate and the second substrate in the frame region, the second substrate is provided with a protrusion protruding toward the liquid crystal layer side, and the first substrate includes a first support substrate and a first substrate-side insulating protrusion in order toward the liquid crystal layer side, the first substrate-side insulating protrusion being in contact with the first support substrate, protruding toward the liquid crystal layer side, facing the protrusion, and being formed in an island shape.
(2) A liquid crystal panel according to an embodiment of the disclosure is such that, in addition to having the configuration of (1) described above, the first substrate-side insulating protrusion has a truncated cone shape or a truncated pyramid shape.
(3) A liquid crystal panel according to an embodiment of the disclosure is such that, in addition to having the configuration of (1) or (2) described above, the sum of the height of the first substrate-side insulating protrusion and the height of the protrusion is equal to the thickness of the liquid crystal layer.
(4) A liquid crystal panel according to an embodiment of the disclosure is such that, in addition to having the configuration of (1), (2), or (3) described above, in a plan view, the entire surface of the protrusion facing the first substrate is included inside the surface of the first substrate-side insulating protrusion facing the second substrate.
(5) A liquid crystal panel according to an embodiment of the disclosure is such that, in addition to having the configuration of (1), (2), (3), or (4) described above, in the display region, the second substrate includes, in order toward the liquid crystal layer side, a second support substrate and a second substrate-side insulating layer in contact with the second support substrate.
(6) A liquid crystal panel according to an embodiment of the disclosure is such that, in addition to having the configuration of (5) described above, the second substrate-side insulating layer has an end portion adjacent to the frame region, and
the end portion is inclined with respect to a main surface of the second support substrate.
(7) A liquid crystal panel according to an embodiment of the disclosure is such that, in addition to having the configuration of (1), (2), (3), (4), (5), or (6) described above, the first substrate further includes a first transparent conductive film disposed on the liquid crystal layer side of the first substrate-side insulating protrusion, and a first insulating layer disposed on the liquid crystal layer side of the first transparent conductive film.
(8) A liquid crystal panel according to an embodiment of the disclosure is such that, in addition to having the configuration of (1), (2), (3), (4), (5), (6), or (7) described above, the second substrate includes a second support substrate, a second transparent conductive film disposed on the liquid crystal layer side of the second support substrate, and a second insulating layer disposed on the liquid crystal layer side of the second transparent conductive film.
(9) A liquid crystal panel according to an embodiment of the disclosure is such that, in addition to having the configuration of (8) described above, in the display region, the second substrate further includes a second substrate-side insulating layer that is disposed between the second support substrate and the second transparent conductive film and is in contact with the second support substrate, and in the frame region, the second substrate further includes a metal layer disposed between the second support substrate and the second transparent conductive film.
(10) A liquid crystal panel according to an embodiment of the disclosure is such that, in addition to having the configuration of (9) described above, the metal layer is in contact with an end portion of the second substrate-side insulating layer.
(11) A liquid crystal panel according to an embodiment of the disclosure is such that, in addition to having the configuration of (9) or (10) described above, the second substrate-side insulating layer has an end portion adjacent to the frame region, the end portion is inclined with respect to a main surface of the second support substrate, and the metal layer is in contact with the end portion.
(12) A liquid crystal panel according to an embodiment of the disclosure is such that, in addition to having the configuration of (1), (2), (3), (4), (5), (6), (7), (8), (9), (10), or (11) described above, the first substrate further includes a first substrate-side metal layer that is in contact with the first support substrate and at least partially overlaps the first substrate-side insulating protrusion in a plan view.
(13) A three-dimensional display device according to another embodiment of the disclosure includes, in order toward a viewer side, a display panel, a polarizer having a transmission axis, the liquid crystal panel according to any one of (1), (2), (3), (4), (5), (6), (7), (8), (9), (10), (11), and (12) described above as an active retarder, and polarized glasses.
(14) A three-dimensional display device according to an embodiment of the disclosure further includes, in addition to having the configuration of (13) described above, a λ/4 retardation plate between the polarizer and the liquid crystal panel, in which the liquid crystal panel can switch a phase difference between λ/2 and 0 nm, and a slow axis of the liquid crystal panel is orthogonal to a slow axis of the λ/4 retardation plate.
(15) A three-dimensional display device according to another embodiment of the disclosure includes, in order toward a viewer side, a display panel, a polarizer having a transmission axis, a first liquid crystal panel formed of the liquid crystal panel according to any one of (1), (2), (3), (4), (5), (6), (7), (8), (9), (10), (11), and (12) described above as an active retarder, a second liquid crystal panel formed of the liquid crystal panel according to any one of (1), (2), (3), (4), (5), (6), (7), (8), (9), (10), (11), and (12) described above as an active retarder, and polarized glasses.
(16) A three-dimensional display device according to an embodiment of the disclosure further includes, in addition to having the configuration of (15) described above, a λ/4 retardation plate between the polarizer and the first liquid crystal panel, in which the first liquid crystal panel and the second liquid crystal panel can each switch a phase difference between λ/4 and 0 nm, a slow axis of the first liquid crystal panel is orthogonal to a slow axis of the λ/4 retardation plate, and a slow axis of the second liquid crystal panel is orthogonal to the slow axis of the λ/4 retardation plate.

According to the disclosure, it is possible to provide a liquid crystal panel capable of curbing white unevenness in a display region near a frame region and a three-dimensional display device including the above liquid crystal panel.

### BRIEF DESCRIPTION OF DRAWINGS

The disclosure will be described with reference to the accompanying drawings, wherein like numbers reference like elements.

FIG. 1 is a schematic cross-sectional view of a liquid crystal panel according to a first embodiment.

FIG. 2 is a schematic cross-sectional view of an active retarder of a comparative embodiment.

FIG. 3 is a schematic cross-sectional view of a liquid crystal panel according to a first modification example of the first embodiment.

FIG. 4 is an exploded schematic view illustrating a polarization state of a three-dimensional display device according to a second embodiment.

FIG. 5 is an exploded schematic view illustrating an axial azimuthal direction of the three-dimensional display device according to the second embodiment.

FIG. 6 is a schematic view illustrating an example of the three-dimensional display device according to the second embodiment.

FIG. 7 is a schematic view illustrating an example of a three-dimensional display device according to a first modification example of the second embodiment.

FIG. 8 is a photograph illustrating a non-lighting black display state of a liquid crystal panel according to Example 1.

FIG. 9 is a photograph illustrating a non-lighting black display state of a liquid crystal panel according to Comparative Example 1.

FIG. 10 is an enlarged photograph of a region surrounded by a dashed line in FIG. 9.

FIG. 11 is a schematic cross-sectional view illustrating a main spacer and a sub-spacer of the liquid crystal panel according to Example 1.

FIG. 12 is a schematic cross-sectional view illustrating a main spacer and a sub-spacer of the liquid crystal panel according to Comparative Example 1.

FIG. 13 is an example of a schematic cross-sectional view of the liquid crystal panel according to Example 1.

FIG. 14 is an example of a schematic cross-sectional view of the liquid crystal panel according to Comparative Example 1.

FIG. 15 is a photograph illustrating the vertical streak unevenness of the liquid crystal panel according to Comparative Example 1.

FIG. 16 is a schematic cross-sectional view illustrating a case in which the liquid crystal panel according to Comparative Example 1 is pressed.

FIG. 17 is a photograph illustrating display unevenness of a display device according to a comparative embodiment.

### DESCRIPTION OF EMBODIMENTS

Embodiments according to the disclosure will be described below. The disclosure is not limited to the contents described in the following embodiments, and appropriate design changes can be made within a scope that satisfies the configuration according to the disclosure. In the following description, the same reference numerals are appropriately used in common among the different drawings for the same parts or parts having similar functions, and repeated description thereof will be omitted as appropriate. The aspects of the disclosure may be combined as appropriate within a scope that does not depart from the gist of the disclosure.

### DEFINITION OF TERMS

In the present specification, the observation face side of a certain member refers to a side of the member closer to a viewer, and the back face side of a certain member refers to a side of the member farther from the viewer.

In the present specification, an azimuthal direction means a direction when a target direction is projected on a screen of a liquid crystal panel, and is represented by an angle (azimuth angle) formed between the target direction and a reference azimuthal direction. When the screen of the liquid crystal panel is viewed from the observation face side (front surface), the angle (azimuth angle) takes a positive angle in the counterclockwise direction and takes a negative angle in the clockwise direction. The angle (azimuth angle) represents a value measured in a state in which the display panel is viewed in a plan view.

In the present specification, the expression “two straight lines (including axes and directions) are orthogonal to each other” means that the straight lines are orthogonal to each other in a plan view unless otherwise specified. The expression “two straight lines (including axes and directions) are parallel to each other” means that the straight lines are parallel to each other in a plan view unless otherwise specified.

In the present specification, the expression “two axes (directions) are orthogonal to each other” means that an angle (absolute value) formed between the axes is in a range of 90±3°, is preferably in a range of 90±1°, is more preferably in a range of 90±0.5°, and is particularly preferably 90° (completely orthogonal). The expression “two axes (directions) are parallel” means that an angle (absolute value) formed between the axes is in a range of 0±3°, is preferably in a range of 0±1°, is more preferably in a range of 0±0.5°, and is particularly preferably 0° (completely parallel).

In the present specification, an axial azimuthal direction refers to a transmission axis of a polarizer, an azimuthal direction of a slow axis of a retardation plate, or an azimuthal direction of a slow axis of a liquid crystal layer, unless otherwise specified.

In the present specification, a direction parallel to a slow axis of the liquid crystal panel is defined as an x-axis, and a direction orthogonal thereto is defined as a y-axis. The term “nx” represents a refractive index in the x-axis direction, the term “ny” represents a refractive index in the y-axis direction, and the term “nz” represents a refractive index in the thickness direction. The refractive index refers to a value for light having a wavelength of 550 nm at 25° C., unless otherwise indicated. The light having a wavelength of 550 nm is light of a wavelength at which visual sensitivity of a person is highest.

In the present specification, an in-plane phase difference (Re) refers to an in-plane phase difference of a layer (film) at 25° C., at a wavelength of 550 nm unless otherwise specified. Re is obtained by Re=(nx−ny)×d, where d is a thickness (nm) of the layer (film). In the present specification, “phase difference” refers to an in-plane phase difference unless otherwise specified.

In the present specification, a phase difference of +/4 means that the slow axis is parallel to the x-axis direction and the absolute value of the phase difference is λ/4. A phase difference of −λ/4 means that the slow axis is parallel to the y-axis direction and the absolute value of the phase difference is λ/4. The absolute value of the phase difference being λ/4 means that the phase difference is 100 nm or more and 176 nm or less, and is preferably 115 nm or more and 160 nm or less. A phase difference being λ/2 means that the phase difference is 225 nm or more and 325 nm or less, and is preferably 240 nm or more and 310 nm or less.

In the present specification, a λ/4 retardation plate is a retardation plate in which the absolute value of the phase difference is λ/4. In the present specification, a λ/2 retardation plate is a retardation plate in which the absolute value of the phase difference is λ/2.

Embodiments according to the disclosure will be described below. The disclosure is not limited to the contents described in the following embodiments, and appropriate design changes can be made within a scope that satisfies the configuration according to the disclosure.

### First Embodiment

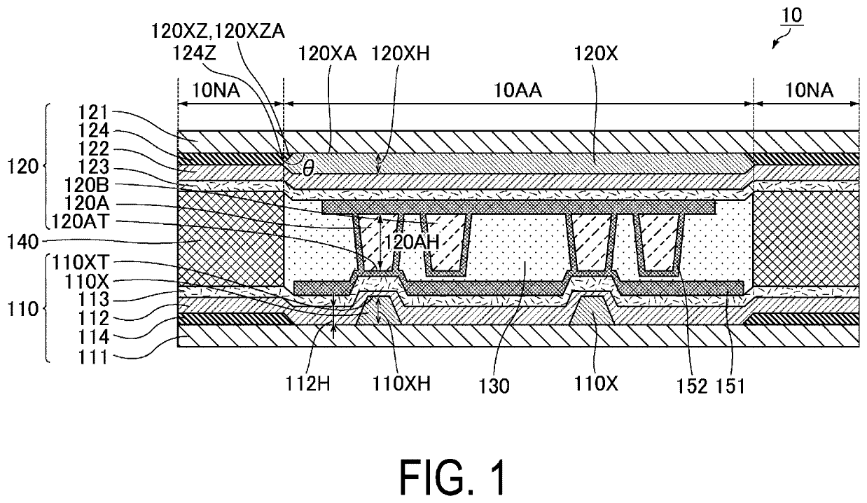

FIG. 1 is a schematic cross-sectional view of a liquid crystal panel according to a first embodiment. As illustrated in FIG. 1, a liquid crystal panel 10 according to the present embodiment is provided with a display region 10AA and a frame region 10NA disposed around the display region 10AA, and includes a first substrate 110 and a second substrate 120 disposed to face the first substrate 110. In the display region 10AA, a liquid crystal layer 130 is disposed between the first substrate 110 and the second substrate 120. In the frame region 10NA, a sealing portion 140 is disposed between the first substrate 110 and the second substrate 120. The second substrate 120 includes a spacer 120A as a protrusion protruding toward the liquid crystal layer 130 side. The first substrate 110 has, in order toward the liquid crystal layer 130 side, a first support substrate 111 and a first substrate-side insulating protrusion 110X that is in contact with the first support substrate 111, protrudes toward the liquid crystal layer 130 side and faces the spacer 120A, and is formed in an island shape.

The first substrate-side insulating protrusion 110X is disposed to face the spacer 120A in this manner, and thus, the spacer 120A can be supported by the first substrate-side insulating protrusion 110X. Thus, it is possible to curb a situation in which the total thickness of a substrate inner side in the display region 10AA near the frame region 10NA (specifically, the sealing portion 140) is larger than the total thickness of a substrate inner side in the display region 10AA at a location away from the frame region 10NA, and to curb unevenness in thickness (also referred to as cell thickness) of the liquid crystal layer 130. As a result, for example, when the liquid crystal panel 10 of the present embodiment is used as an active retarder, it is possible to curb white unevenness in the display region 10AA near the frame region 10NA. Here, the “substrate inner side” refers to a region between a support substrate (for example, glass substrate) included in the first substrate 110 and a support substrate (for example, glass substrate) included in the second substrate 120. When the support substrate is a glass substrate, the “substrate inner side” is particularly referred to as “glass substrate inner side”.

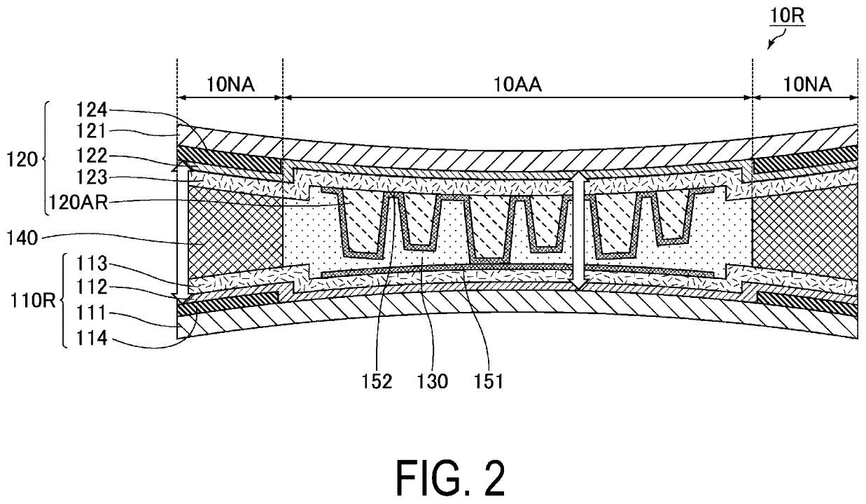

Here, an active retarder according to a comparative embodiment will be described. FIG. 2 is a schematic cross-sectional view of the active retarder according to the comparative embodiment. As illustrated in FIG. 2, a liquid crystal panel 10R according to the comparative embodiment is provided with a display region 10AA and a frame region 10NA disposed around the display region 10AA, and includes a first substrate 110R and a second substrate 120 disposed to face the first substrate 110R. In the display region 10AA, a liquid crystal layer 130 is disposed between the first substrate 110R and the second substrate 120, and in the frame region 10NA, a sealing portion 140 is disposed between the first substrate 110R and the second substrate 120.

More specifically, in the display region 10AA, the first substrate 110R includes a first support substrate 111, a first transparent conductive film 112, and a first insulating layer 113 in order toward the liquid crystal layer 130 side. In the display region 10AA, the second substrate 120 includes a second support substrate 121, a second transparent conductive film 122, a second insulating layer 123, and a spacer 120AR in order toward the liquid crystal layer 130 side.

In the frame region 10NA, the first substrate 110R includes the first support substrate 111, a first metal layer 114, the first transparent conductive film 112, and the first insulating layer 113 in order toward a sealing portion 140 side. In the frame region 10NA, the second substrate 120 includes a second support substrate 121, a second metal layer 124, a second transparent conductive film 122, and a second insulating layer 123 in order toward the sealing portion 140 side.

A first alignment film 151 is disposed between the first substrate 110 and the liquid crystal layer 130, and a second alignment film 152 is disposed between the second substrate 120 and the liquid crystal layer 130.

The first support substrate 111 and the second support substrate 121 are glass substrates. The thicknesses of the first support substrate 111 and the second support substrate 121 are each 0.5 mm. The first transparent conductive film 112 is 70 nm in thickness. The first insulating layer 113 is 530 nm in thickness. The second transparent conductive film 122 is 140 nm in thickness. The second insulating layer 123 is 680 nm in thickness. The thicknesses of the first alignment film 151 and the second alignment film 152 are each 90 nm. The thicknesses of the first metal layer 114 and the second metal layer 124 are each 360 nm. An optimum cell thickness of the liquid crystal panel 10R (thickness of the liquid crystal layer 130) is approximately 1.62 μm.

In the display region 10AA, the first transparent conductive film 112, the first insulating layer 113, the first alignment film 151, the liquid crystal layer 130, the second alignment film 152, the second insulating layer 123, and the second transparent conductive film 122 are disposed between the first support substrate 111 and the second support substrate 121. Accordingly, the total thickness of the glass substrate inner side in the display region 10AA, that is, the total thickness of the glass substrate inner side interposed between the first support substrate 111 and the second support substrate 121 in the display region 10AA is 3220 nm.

In the frame region 10NA, the first metal layer 114, the first transparent conductive film 112, the first insulating layer 113, the sealing portion 140, the second insulating layer 123, the second transparent conductive film 122, and the second metal layer 124 are disposed between the first support substrate 111 and the second support substrate 121.

In consideration of the display quality, the total thickness of the glass substrate inner side in the frame region 10NA is expected to be equal to the total thickness of the glass substrate inner side in the display region 10AA. In the case of a voltage input of a common transfer scheme, the total thickness of the glass substrate inner side in the frame region 10NA is usually adjusted with conductive beads for sealing and a spacer for sealing.

In the case of the liquid crystal panel 10R according to the comparative embodiment, strictly speaking, conductive beads for sealing (diameter: 1.51 μm) and a spacer for sealing (diameter: 1.08 μm) having the diameters that cause the height of the sealing portion 140 to be 1080 nm should be used. However, the minimum diameter of the conductive beads for sealing in the products commercially available and the products developed by material manufacturers is 3.0 μm, and in this case, the diameter of the spacer for sealing is 2.0 μm. Since the height of the sealing portion 140 is substantially equal to the diameter of the spacer for sealing, the total thickness of the glass substrate inner side in the frame region 10NA is 4140 nm, which is larger than the total thickness of the glass substrate inner side in the display region 10AA by 920 nm.

Due to this difference in total thickness, in the liquid crystal panel 10R according to the comparative embodiment, the sealing portion 140 serves as a column, so that the height of the display region 10AA near the sealing portion 140 cannot be curbed, and the cell thickness becomes large. That is, the total thickness of the glass substrate inner side in the display region 10AA near the sealing portion 140 is larger than the total thickness of the glass substrate inner side in the display region 10AA at a location away from the frame region 10NA, so that a desired retardation cannot be obtained in the display region 10AA near the sealing portion 140. As a result, when the liquid crystal panel 10R according to the comparative embodiment is used as an active retarder, display unevenness is visually recognized in the display region 10AA near the sealing portion 140 (near the frame region 10NA). Since an optimum cell thickness of the liquid crystal panel 10R according to the comparative embodiment used as an active retarder is as narrow as 2.0 μm or less (for example, approximately 1.62 μm), uniformity of the cell thickness is an important issue.

Here, a method of calculating the diameter of the spacer for sealing is described. An optimum diameter of the spacer for sealing is a length obtained by multiplying the diameter of the conductive beads for sealing by the compressibility of the conductive beads for sealing. For example, when conductive beads for sealing having a diameter of 3.0 μm and a compressibility of 0.714 are used, the optimum diameter of the spacer for sealing is 2.14 μm according to Equation S1 given below.

Optimum diameter of spacer for sealing=3.0 μm×0.714=2.14 μm (Equation S1)

From the lineup of commercially available spacers for sealing, a spacer for sealing having a diameter of 2.0 μm is used in the liquid crystal panel according to the comparative embodiment.

On the other hand, in the liquid crystal panel 10 according to the present embodiment, the first substrate-side insulating protrusion 110X in contact with the first support substrate 111, protruding toward the liquid crystal layer 130 side, facing the spacer 120A, and formed in an island shape is disposed in a region overlapping the spacer 120A in a plan view, and thus it is possible to curb unevenness in the cell thickness. As a result, when the liquid crystal panel 10 according to the present embodiment is used as an active retarder, it is possible to curb white unevenness in the display region 10AA near the frame region 10NA. Hereinafter, the liquid crystal panel 10 according to the present embodiment will be described in detail.

As illustrated in FIG. 1, the liquid crystal panel 10 according to the present embodiment is provided with the display region 10AA and the frame region 10NA disposed around the display region 10AA, and includes the first substrate 110 and the second substrate 120 disposed to face the first substrate 110. In the display region 10AA, the liquid crystal layer 130 is disposed between the first substrate 110 and the second substrate 120, and in the frame region 10NA, the sealing portion 140 is disposed between the first substrate 110 and the second substrate 120. The display region 10AA is a region in which the phase difference may change. Here, “a certain member is disposed to face another member” means, for example, that a certain member overlaps another member in a plan view. In this case, in the plan view, it is preferable that 90% or more and 100% or less of the area of the certain member overlap the other member, and is more preferable that 95% or more and 100% or less of the area of the certain member overlap the other member.

The first substrate 110 further includes the first transparent conductive film 112 disposed on the liquid crystal layer 130 side of the first substrate-side insulating protrusion 110X, and the first insulating layer 113 disposed on the liquid crystal layer 130 side of the first transparent conductive film 112.

The second substrate 120 includes the second support substrate 121, the second transparent conductive film 122 disposed on the liquid crystal layer 130 side of the second support substrate 121, and the second insulating layer 123 disposed on the liquid crystal layer 130 side of the second transparent conductive film 122.

In the display region 10AA, the first substrate 110 includes the first support substrate 111, the first substrate-side insulating protrusion 110x, the first transparent conductive film 112, and the first insulating layer 113 in order toward the liquid crystal layer 130 side.

In the display region 10AA, the second substrate 120 includes the second support substrate 121, the second transparent conductive film 122, the second insulating layer 123, and the spacer 120A in order toward the liquid crystal layer 130 side.

In the frame region 10NA, the first substrate 110 includes the first support substrate 111, the first metal layer 114, the first transparent conductive film 112, and the first insulating layer 113 in order toward the sealing portion 140 side.

In the frame region 10NA, it is preferable that the first substrate 110 include the first metal layer 114 disposed between the first support substrate 111 and the first transparent conductive film 112. By adopting such a configuration, for example, a signal from the second substrate 120 can be input by being conducted from the first metal layer 114 through the conductive beads for sealing included in the sealing portion 140.

In the frame region 10NA, the second substrate 120 includes the second support substrate 121, the second metal layer 124, the second transparent conductive film 122, and the second insulating layer 123 in order toward the sealing portion 140 side.

In the frame region 10NA, it is preferable that the second substrate 120 include the second metal layer 124 as a metal layer disposed between the second support substrate 121 and the second transparent conductive film 122. By adopting such a configuration, for example, a signal from the first substrate 110 can be input by being conducted from the second metal layer 124 through the conductive beads for sealing included in the sealing portion 140.

The first alignment film 151 is disposed between the first substrate 110 and the liquid crystal layer 130, and the second alignment film 152 is disposed between the second substrate 120 and the liquid crystal layer 130.

The first substrate-side insulating protrusion 110X is in contact with the first support substrate 111 in a region overlapping the spacer 120A in a plan view, and protrudes toward the liquid crystal layer 130 side to face the spacer 120A.

The shape of the first substrate-side insulating protrusion 110X is not particularly limited, but the first substrate-side insulating protrusion 110X may be, for example, a truncated cone shape, a cylindrical shape, an elliptical truncated cone shape, an elliptical cylindrical shape, a truncated pyramid shape, a prism shape, and the like. Examples of the truncated pyramid include a quadrangular truncated pyramid, and the like. Examples of the prism include a quadrangular prism, and the like. It is preferable that the first substrate-side insulating protrusion 110X have a truncated cone shape or a truncated pyramid shape.

As the first substrate-side insulating protrusion 110x, an organic insulating layer may be used, for example. Examples of the organic insulating layer may include organic films such as an acrylic resin, a polyimide resin and a novolac resin, and layered bodies thereof.

The first substrate-side insulating protrusion 110X may have a single-layer structure configured with one insulating layer, or a layered structure configured with a plurality of insulating layers. In addition, the entire surface of the first substrate-side insulating protrusion 110X on the first support substrate 111 side may be in contact with the first support substrate 111, or a part of the surface of the first substrate-side insulating protrusion 110X on the first support substrate 111 side may be in contact with the first support substrate 111. For example, another member (for example, a metal wiring line (a first substrate-side metal layer 115 or the like to be described later)) may be provided between the first support substrate 111 and the first substrate-side insulating protrusion 110x, and a portion of the surface of the first substrate-side insulating protrusion 110X on the first support substrate 111 side which does not overlap the other member may be in contact with the first support substrate 111.

The first substrate-side insulating protrusion 110X protrudes toward the liquid crystal layer 130 side with respect to an adjacent layer (the first transparent conductive film 112 in the present embodiment) in contact with the first support substrate 111 in a region that does not overlap the spacer 120A in a plan view. A height 110XH (thickness) of the first substrate-side insulating protrusion 110X is preferably 1.0 times or more and 7.0 times or less a height 112H of the first transparent conductive film 112 as the adjacent layer, more preferably 2.0 times or more and 6.0 times or less, and even more preferably 3.0 times or more and 5.0 times or less.

For example, it is preferable that the height 112H of the first transparent conductive film 112 as the adjacent layer be 10 nm or more and 200 nm or less, and the height 110XH of the first substrate-side insulating protrusion 110X be 210 nm or more and 500 nm or less, it is more preferable that the height 112H of the first transparent conductive film 112 as the adjacent layer be 15 nm or more and 160 nm or less, and the height 110XH of the first substrate-side insulating protrusion 110X be 220 nm or more and 400 nm or less, and it is more preferable that the height 112H of the first transparent conductive film 112 as the adjacent layer be 20 nm or more and 120 nm or less, and the height 110XH of the first substrate-side insulating protrusion 110X be 250 nm or more and 350 nm or less.

The height 112H of the first transparent conductive film 112 as the adjacent layer refers to a distance from the surface of the first transparent conductive film 112 on the first support substrate 111 side to the surface on the second substrate 120 side. The height 110XH of the first substrate-side insulating protrusion 110X refers to a distance from the surface of the first substrate-side insulating protrusion 110X on the first support substrate 111 side to the surface on the second substrate 120 side. Here, the surface on the first support substrate 111 side refers to the surface closest to the first support substrate 111, and the surface on the second substrate 120 side refers to the surface closest to the second substrate 120.

The first substrate-side insulating protrusion 110X is disposed to face the spacer 120A as the protrusion. In a plan view, it is preferable that an entire surface 120AT of the spacer 120A as the protrusion which faces the first substrate 110 be included on the inner side of the surface 110XT of the first substrate-side insulating protrusion 110X facing the second substrate 120. By adopting such a configuration, it is possible to comprehensively dispose the surface 110XT of the first substrate-side insulating protrusion 110X with respect to the surface 120AT of the spacer 120A facing the first substrate 110, and the cell thickness can be specified more effectively. Here, the entire surface may be substantially the entirety of the surface, and may be, for example, an area including 90% or more and 100% or less of the entire surface. The expression “being included on the inner side something” also includes a case of matching something completely.

It is preferable that the first substrate-side insulating protrusion 110X abut on the spacer 120A serving as the protrusion (the first substrate-side insulating protrusion 110X and the spacer 120A face each other with a member other than the liquid crystal layer 130 interposed therebetween and are continuous with each other). More specifically, in a normal state in which no load is applied to the liquid crystal panel 10, it is preferable for a top portion of the first substrate-side insulating protrusion 110X (the surface 110XT on the second substrate 120 side) to abut on a top portion of the spacer 120A (the surface 120AT on the first substrate 110 side). By adopting such a configuration, a distance (cell thickness) between the first substrate 110 and the second substrate 120 can be specified. Such a spacer 120A is also referred to as a main spacer. In the present specification, the term “abut” includes not only a case of direct contact but also a case of contact via another member.

The sum of the height 110XH of the first substrate-side insulating protrusion 110X and the height 120AH of the spacer 120A as the protrusion is preferably equal to the thickness of the liquid crystal layer 130 (cell thickness (for example, 1.62 μm)). By adopting such a configuration, the cell thickness may be specified more effectively. The expression “heights are equal to each other” means that the heights are substantially equal to each other, and for example, refers to a case in which a difference in height is 0 nm or more and 30 nm or less.

It is preferable that the total area of all of the first substrate-side insulating protrusions 110X provided on the first substrate 110 account for 0.01% or more and 1.00% or less of the area of the display region 10AA in a plan view, it is more preferable that the total area account for 0.01% or more and 0.50% or less of the area, and it is even more preferable that the total area account for 0.01% or more and 0.1% or less of the area.

As described above, the spacer 120A included in the second substrate 120 is a main spacer. The spacer 120A is provided above the second support substrate 121 and protrudes to the liquid crystal layer 130 side. The spacer 120A has a function of maintaining a gap between the first substrate 110 and the second substrate 120 (thickness of the liquid crystal layer 130) in a normal state in which no load is applied to the liquid crystal panel 10. In the normal state in which no load is applied to the liquid crystal panel 10, the spacer 120A abuts on the first substrate 110 (more specifically, the first substrate-side insulating protrusion 110X).

It is sufficient for the spacer 120A as the protrusion to protrude toward the liquid crystal layer 130 side. The height 120AH of the spacer 120A is not particularly limited, but is, for example, 0.1 μm or more and 3.0 μm or less.

The second substrate 120 may further include a sub-spacer 120B as a second protrusion that protrudes toward the liquid crystal layer 130 side and does not face the first substrate-side insulating protrusion 110X. In a normal state in which no load is applied to the liquid crystal panel 10, the sub-spacer 120B does not abut on the first substrate 110. However, when a load is applied to the liquid crystal panel 10, the sub-spacer 120B abuts on the first substrate 110 (the sub-spacer 120B and the first substrate 110 face each other with a member other than the liquid crystal layer 130 interposed therebetween and are continuous with each other). As a result, the first substrate 110 and the second substrate 120 can be supported by both the spacer 120A and the sub-spacer 120B, thereby making it possible to increase the load capacity.

The spacer 120A and the sub-spacer 120B may have the same shape and size, or may have different shapes and sizes. However, they may preferably have the same shape and size. By adopting such a configuration, the sub-spacer 120B can be easily provided. Specifically, it is preferable that the height of the sub-spacer 120B be equal to the height of the spacer 120A.

It is preferable that the spacer 120A and the sub-spacer 120B contain a cured product of a photosensitive resin. Examples of the photosensitive resin include a resin having an ultraviolet reactive functional group. The spacer 120A and the sub-spacer 120B are obtained by applying a photosensitive resin-containing composition onto the second support substrate 121 and patterning the applied composition by a known photolithography method.

The first substrate 110 includes the first transparent conductive film 112 disposed on the liquid crystal layer 130 side of the first substrate-side insulating protrusion 110x, and the first insulating layer 113 disposed on the liquid crystal layer 130 side of the first transparent conductive film 112. By adopting such a configuration, leakage of the first substrate 110 and the second substrate 120 can be curbed.

The second substrate 120 includes the second support substrate 121, the second transparent conductive film 122 disposed on the liquid crystal layer 130 side of the second support substrate 121, and the second insulating layer 123 disposed on the liquid crystal layer 130 side of the second transparent conductive film 122. By adopting such a configuration, leakage of the first substrate 110 and the second substrate 120 can be curbed.

In a display region 1AA, it is preferable that the second substrate 120 have, in order toward the liquid crystal layer 130 side, the second support substrate 121 and a second substrate-side insulating layer 120X in contact with the second support substrate 121. By adopting such a configuration, vertical streak unevenness can be curbed when the liquid crystal panel 10 according to the present embodiment is used as an active retarder.

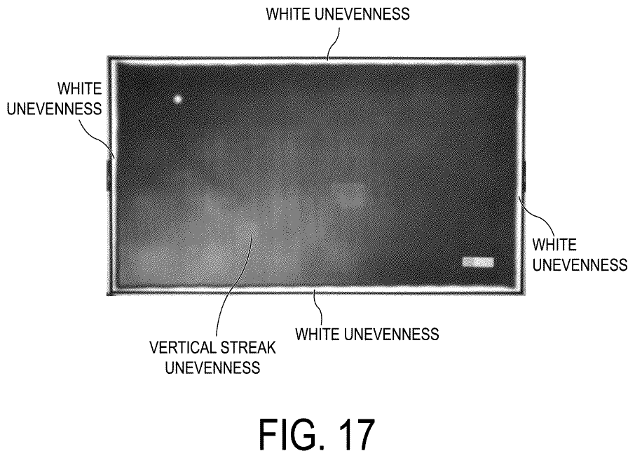

Here, in a display device using the liquid crystal panel 10R according to the comparative embodiment as a 3D active retarder, vertical streak unevenness occurs at a pitch of 20 to 30 mm in the display region 10AA, as illustrated in FIG. 17. It is conceivable that the cell thickness becomes non-uniform due to interference of the waviness of the glass substrate generated at the time of manufacturing the glass substrate, thereby causing vertical streak unevenness.

The second substrate-side insulating layer 120X according to the present embodiment is disposed between the second support substrate 121 and the second transparent conductive film 122 in the display region 1AA. The second substrate-side insulating layer 120X is disposed on the entire surface of the display region 10AA. The second substrate-side insulating layer 120X is provided over both a region in which the spacer 120A is disposed and a region in which the spacer 120A is not disposed in the display region 10AA in a plan view.

As the second substrate-side insulating layer 120X, an organic insulating layer can be used, for example. Examples of the organic insulating layer may include organic films such as an acrylic resin, a polyimide resin and a novolac resin, and layered bodies thereof.

The second substrate-side insulating layer 120X may have a single-layer structure configured with one insulating layer, or a layered structure configured with a plurality of insulating layers. The second substrate-side insulating layer 120X can be formed, for example, from spin-on glass (SOG) or the like.

In addition, the entire surface of the second substrate-side insulating layer 120X on the second support substrate 121 side may be in contact with the second support substrate 121, or a part of the surface of the second substrate-side insulating layer 120X on the second support substrate 121 side may be in contact with the second support substrate 121.

For example, another member (for example, a metal wiring line) may be provided between the second support substrate 121 and the second substrate-side insulating layer 120X, and a portion of the surface of the second substrate-side insulating layer 120X on the second support substrate 121 side which does not overlap the other member may be in contact with the second support substrate 121.

It is preferable that the second substrate-side insulating layer 120X have a flat surface on the liquid crystal layer 130 side. By adopting such a configuration, it is possible to reduce the influence of the waviness of the substrate surface generated at the time of manufacturing the second support substrate 121, on the liquid crystal layer 130. As a result, the unevenness in thickness of the liquid crystal layer 130 can be curbed, and when the liquid crystal panel 10 according to the present embodiment is used as an active retarder, vertical streak unevenness can be effectively curbed. In the present specification, “being flat” means, for example, that the ten-point average roughness (Rzjis) according to JIS B0601 is 0 μm or more and 0.2 μm or less.

The second substrate-side insulating layer 120X is provided such that the total thickness of the glass substrate inner side in the display region 10AA is equal to the total thickness of the glass substrate inner side in the frame region 10NA. By adopting such a configuration, it is possible to reduce the difference between the cell thickness in the display region 10AA near the frame region 10NA and the cell thickness in the display region 10AA at a location away from the frame region 10NA. As a result, when the liquid crystal panel 10 according to the present embodiment is used as an active retarder, it is possible to effectively curb white unevenness in the display region 10AA near the frame region 10NA and enhance the performance of the active retarder.

It is preferable that the second substrate-side insulating layer 120X have an end portion 120XZ adjacent to the frame region 10NA, and the end portion 120XZ be inclined with respect to a main surface of the second support substrate 121. As shown in FIG. 1, an angle θ formed by a surface 120XA of the second substrate-side insulating layer 120X in contact with the second support substrate 121 (in contact with the main surface of the second support substrate 121) and an end surface 120XZA of the second substrate-side insulating layer 120X configuring the end portion 120XZ may be 91° or more and less than 180° in a cross-sectional view. The angle θ is preferably 95° or more and 175° or less, more preferably 100° or more and 170° or less, and even more preferably 110° or more and 170° or less. The angle θ may be an acute angle.

It is more preferable that the height 120XH of the second substrate-side insulating layer 120X be, for example, 500 nm or more and 2500 nm or less. The height 120XH of the second substrate-side insulating layer 120X refers to a distance from the surface of the second substrate-side insulating layer 120X on the second support substrate 121 side to the surface on the first substrate 110 side.

The second metal layer 124 is in contact with the end portion 120XZ of the second substrate-side insulating layer 120X. Specifically, the second metal layer 124 has an end portion 124Z adjacent to the display region 10AA, and the end portion 124Z of the second metal layer 124 is in contact with the end portion 120XZ of the second substrate-side insulating layer 120X.

More specifically, the second substrate-side insulating layer 120X has the end portion 120XZ adjacent to the frame region 10NA, the end portion 120XZ is inclined with respect to the main surface of the second support substrate 121, and the second metal layer 124 is in contact with the end portion 120XZ.

Examples of the first support substrate 111 and the second support substrate 121 include insulating substrates such as a glass substrate and a plastic substrate. Examples of materials for the glass substrate include glass such as float glass and soda glass. Examples of materials for the plastic substrate include plastics such as polyethylene terephthalate, polybutylene terephthalate, polyether sulfone, polycarbonate, and alicyclic polyolefin.

Each of the thicknesses of the first support substrate 111 and the second support substrate 121 is not particularly limited, but is preferably, for example, 0.1 mm or more and 1.0 mm or less.

Examples of the first transparent conductive film 112 and the second transparent conductive film 122 include transparent conductive materials such as indium tin oxide (ITO), indium zinc oxide (IZO), zinc oxide (ZnO) and tin oxide (SnO), and alloys thereof. The first transparent conductive film 112 and the second transparent conductive film 122 can be formed in such a manner that a single layer or a plurality of layers are film-formed by a sputtering method or the like, and then patterned by a photolithography method.

The thickness of the first transparent conductive film 112 is not particularly limited, but is preferably, for example, 10 nm or more and 150 nm or less. The thickness of the second transparent conductive film 122 is not particularly limited, but is preferably, for example, 10 nm or more and 250 nm or less.

Examples of the first insulating layer 113 and the second insulating layer 123 may include an inorganic insulating layer, an organic insulating layer, and a layered body of the above-mentioned organic insulating layer and inorganic insulating layer. Examples of the inorganic insulating layer may include inorganic films such as silicon nitride (SiNx) and silicon oxide (SiO₂), and layered films thereof. Examples of the organic insulating layer may include organic films such as an acrylic resin, a polyimide resin and a novolac resin, and layered bodies thereof.

The thickness of the first insulating layer 113 is not particularly limited, but is preferably, for example, 70 nm or more and 750 nm or less. The thickness of the second insulating layer 123 is not particularly limited, but is preferably, for example, 70 nm or more and 900 nm or less.

The first insulating layer 113 and the second insulating layer 123 are insulating layers for preventing the leakage of the first substrate 110 and the second substrate 120. When the cell thickness is relatively large (for example, 2.0 μm or more), at least one of the first insulating layer 113 and the second insulating layer 123 may not be disposed.

The first metal layer 114 and the second metal layer 124 (hereinafter, also simply referred to as metal layers) are layers containing a metal. Examples of the metal layer include Mo/Al, Al, and Cu. The metal layer is formed by, for example, providing a metal thin film using a sputtering method, and then patterning the metal thin film using a photolithography method.

Each of the thicknesses of the first metal layer 114 and the second metal layer 124 is not particularly limited, but is preferably, for example, 150 nm or more and 550 nm or less.

The liquid crystal layer 130 contains a liquid crystal material. Then, the amount of light to be transmitted is controlled by applying a voltage to the liquid crystal layer 130 to change an alignment state of the liquid crystal molecules in the liquid crystal material in accordance with the applied voltage. The liquid crystal molecules may have a positive or negative value of dielectric constant anisotropy (Ac) as defined by an equation given below. The liquid crystal molecules having positive anisotropy of dielectric constant is also referred to as positive-working liquid crystal, and the liquid crystal molecules having negative anisotropy of dielectric constant is also referred to as negative-working liquid crystal. The major axis direction of the liquid crystal molecules is a direction of a slow axis. The liquid crystal molecules take a homogeneous alignment in a state in which a voltage is not applied (voltage non-applied state), and the major axis direction of the liquid crystal molecules in the voltage non-applied state is also referred to as a direction of the initial alignment of the liquid crystal molecules.

Δε=(dielectric constant in major axis direction of liquid crystal molecules)−(dielectric constant in minor axis direction of liquid crystal molecules) (Equation L)

Since the active retarder needs to perform switching following ultrahigh-speed image switching, the cell thickness of the liquid crystal layer 130 is preferably thin. The thickness of the liquid crystal layer 130 is preferably, for example, 1.0 μm or more and 2.0 μm or less.

In the manufacture of a liquid crystal panel having such a small cell thickness, it may be difficult to control the cell thickness including manufacturing variations. However, in the present embodiment, by measuring the height 120AH of the spacer 120A and the height 110XH of the first substrate-side insulating protrusion 110X in advance, it is possible to select a combination of the first substrate 110 and the second substrate 120 capable of providing an optimum cell thickness and to bond them together, thereby making it possible to easily control the cell thickness.

The sealing portion 140 preferably includes, for example, a cured product of a curable resin. Examples of the curable resin include a resin having at least one of an ultraviolet reactive functional group and a thermal reactive functional group. The curable resin preferably has a (meth)acryloyl group and/or an epoxy group because the curing reaction proceeds rapidly and the adhesiveness is favorable. For example, (meth)acrylate, an epoxy resin, and the like may be used as such a curable resin. These resins may be used alone, or two or more kinds thereof may be used in combination. In the present specification, (meth)acrylic refers to acrylic or methacrylic.

The first alignment film 151 and the second alignment film 152 (hereinafter, also simply referred to as alignment films) each have a function of controlling the alignment of the liquid crystal molecules contained in the liquid crystal layer 130. When a voltage applied to the liquid crystal layer 130 is lower than a threshold voltage (including voltage non-application), the alignment of the liquid crystal molecules in the liquid crystal layer 130 is controlled mainly by the function of the alignment films.

As the material of the alignment film, a general material in the field of liquid crystal display panels such as a polymer having polyimide in the main chain, a polymer having polyamic acid in the main chain, and a polymer having polysiloxane in the main chain can be used. The alignment film can be formed by applying an alignment film material, and the coating method is not particularly limited. For example, flexographic printing, ink-jet coating, or the like can be used.

The alignment film may be a horizontal alignment film in which liquid crystal compounds are substantially horizontally aligned with respect to the film plane, or may be a vertical alignment film in which liquid crystal molecules are substantially vertically aligned with respect to the film plane. The alignment film may be a photo-alignment film having a photo-functional group and having been subjected to photo-alignment treatment as alignment treatment, may be a rubbing alignment film having been subjected to rubbing treatment as alignment treatment, or may be an alignment film not having been subjected to alignment treatment.

As a method of the alignment treatment applied to the alignment film, a rubbing method of rubbing the alignment film surface with a roller or the like has been widely used typically. On the other hand, in recent years, a photo-alignment method of irradiating an alignment film surface with light has been widely developed as a method of alignment treatment in place of the rubbing method. According to the photo-alignment method, the alignment treatment can be performed without coming into contact with the surface of the alignment film, and thus, unlike the rubbing treatment, there is an advantage that generation of dirt, dust, and the like during the alignment treatment can be curbed.

Each of the thicknesses of the first alignment film 151 and the second alignment film 152 is not particularly limited, but is preferably, for example, 10 nm or more and 300 nm or less.

### First Modification Example of First Embodiment

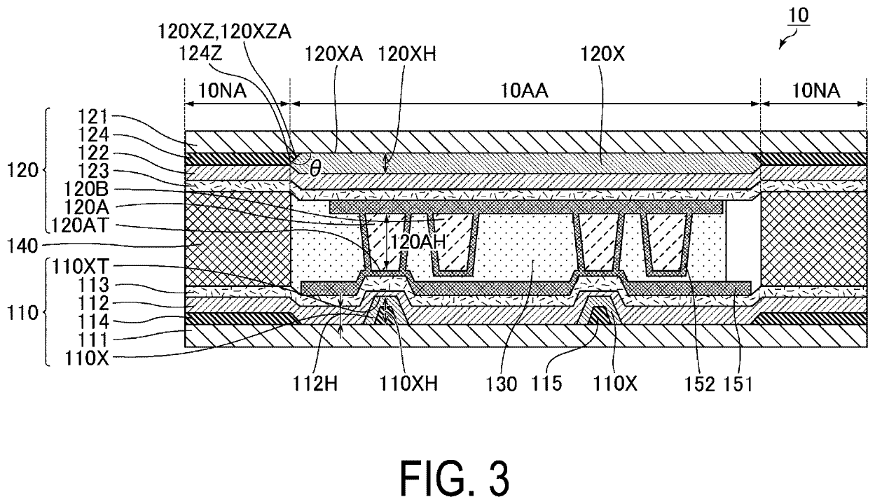

FIG. 3 is a schematic cross-sectional view of a liquid crystal panel according to a first modification example of the first embodiment. As illustrated in FIG. 3, the first substrate 110 may further include the first substrate-side metal layer 115 that is in contact with the first support substrate 111 and at least partially overlaps the first substrate-side insulating protrusion 110X in a plan view.

For example, in FIG. 3, the first substrate-side metal layer 115 is continuous in the depth direction of the paper surface, but the first substrate-side insulating protrusion 110X is not continuous in the depth direction of the paper surface, and thus, the first substrate-side metal layer 115 is not completely covered by the first substrate-side insulating protrusion 110X and is in contact with the first transparent conductive film 112. By adopting such a configuration, the first substrate-side metal layer 115 can function as a wiring line for reducing the resistance of the first transparent conductive film 112.

The first substrate-side metal layer 115 is disposed, for example, in the same layer as the first metal layer 114. The first substrate-side metal layer 115 can be formed, for example, in the same manner as the first metal layer 114.

The first substrate-side insulating protrusion 110X according to the present modification example is partially in contact with the first support substrate 111. That is, the central portion of the surface of the first substrate-side insulating protrusion 110X on the first support substrate 111 side is in contact with the first metal layer 114, and the peripheral portion located around the central portion is in contact with the first support substrate 111.

### Second Embodiment

In the present embodiment, features unique to the present embodiment will be mainly described, and a description of contents overlapping the above-described first embodiment will be omitted. In the present embodiment, a three-dimensional display device provided with the liquid crystal panel according to the first embodiment will be described.

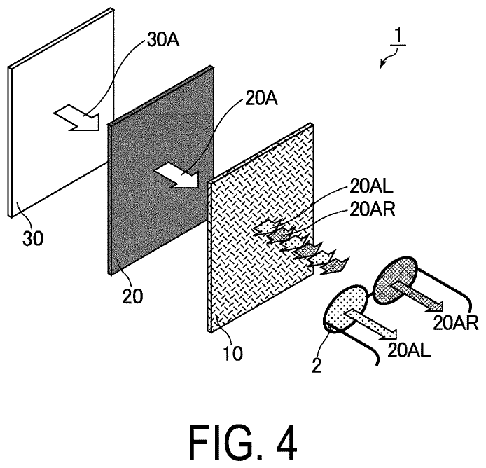

FIG. 4 is an exploded schematic view illustrating a polarization state of a three-dimensional display device according to the second embodiment. As illustrated in FIG. 4, a three-dimensional display device 1 according to the present embodiment includes a display panel 20, a liquid crystal panel 10 as an active retarder, and polarized glasses 2 in order toward a viewer U side. The liquid crystal panel 10 functions as an active retarder. The display panel 20 is also referred to as a main panel. The polarized glasses 2 are also referred to as 3D glasses.

The display panel 20 displays an image 20A. The image 20A includes a right-eye image 20AR and a left-eye image 20AL. The display panel 20 has a function of sequentially displaying the right-eye image 20AR and the left-eye image 20AL by switching the images at predetermined time intervals.

The liquid crystal panel 10 is an optical switching element synchronized with the image switching of the display panel 20, and has a function of differentiating the polarization states of the right-eye image 20AR and the left-eye image 20AL. For example, the liquid crystal panel 10 has a function of converting the right-eye image 20AR into one of right-handed circularly-polarized light and left-handed circularly-polarized light when the right-eye image 20AR is incident on the liquid crystal panel 10, and has a function of converting the left-eye image 20AL into the other one of right-handed circularly-polarized light and left-handed circularly-polarized light when the left-eye image 20AL is incident on the liquid crystal panel 10.

The polarized glasses 2 are designed in such a manner that the polarized light of the right-eye image 20AR passes through the right-eye side and the polarized light of the left-eye image 20AL passes through the left-eye side. By adopting such a configuration, the viewer can obtain 3D display.

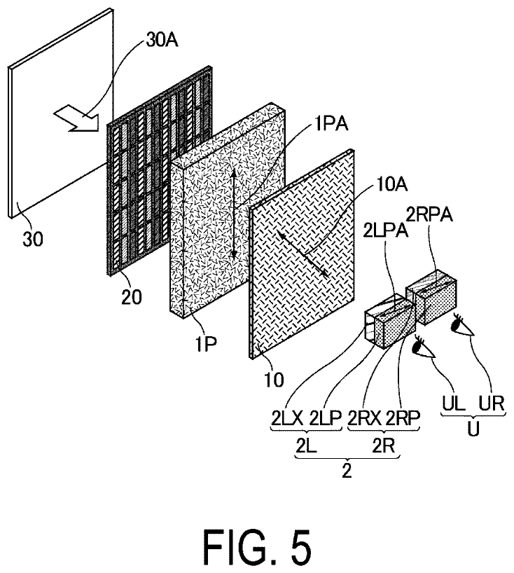

FIG. 5 is an exploded schematic view illustrating an axial azimuthal direction of the three-dimensional display device according to the second embodiment. The three-dimensional display device 1 according to the present embodiment will be described in more detail with reference to FIG. 5. The three-dimensional display device 1 according to the present embodiment includes the display panel 20, a polarizer 1P having a transmission axis 1PA, the liquid crystal panel 10, and the polarized glasses 2 in order toward the viewer U side. By adopting such a configuration, it is possible to achieve three-dimensional display while curbing white unevenness in a display region near a frame region, and vertical streak unevenness in the display region.

The polarized glasses 2 include a right-eye lens 2R corresponding to the right eye UR of the viewer U and a left-eye lens 2L corresponding to the left eye UL of the viewer U. The right-eye lens 2R includes a right-eye retardation plate 2RX and a right-eye polarizer 2RP having a right-eye transmission axis 2RPA. The left-eye lens 2L includes a left-eye retardation plate 2LX and a left-eye polarizer 2LP having a left-eye transmission axis 2LPA. The term “polarizer” in the present specification means a linear polarizer unless otherwise specified.

The right-eye transmission axis 2RPA and the left-eye transmission axis 2LPA are parallel to each other. The transmission axis 1PA is orthogonal to the right-eye transmission axis 2RPA and the left-eye transmission axis 2LPA. One of the right-eye retardation plate 2RX and the left-eye retardation plate 2LX is a −λ/4 retardation plate, and the other one is a +λ/4 retardation plate. Specifically, the transmission axis 1PA is disposed in the vertical direction of the display panel 20, the right-eye transmission axis 2RPA and the left-eye transmission axis 2LPA are disposed in the horizontal direction of the display panel 20, the right-eye retardation plate 2RX is a +λ/4 retardation plate, and the left-eye retardation plate 2LX is a −λ/4 retardation plate.

An angle formed between a slow axis 10A of the liquid crystal panel 10 and the transmission axis 1PA is preferably 40° or more and 50° or less, more preferably 43° or more and 47° or less, and particularly preferably 45°.

The display panel 20 displays the image 20A including the right-eye image 20AR and the left-eye image 20AL. The image 20A from the display panel 20 becomes linearly polarized light in the vertical direction by passing through the polarizer 1P, and is emitted to the liquid crystal panel 10. The display panel 20 sequentially displays the right-eye image 20AR and the left-eye image 20AL by switching at predetermined time intervals.

When the image 20A displayed on the display panel 20 is the right-eye image 20AR, the liquid crystal panel 10 gives the same phase difference (for example, +λ/4) as that of the right-eye retardation plate 2RX to the light incident on the liquid crystal panel 10. When the image 20A displayed on the display panel 20 is the left-eye image 20AL, the liquid crystal panel 10 gives the same phase difference (for example, −λ/4) as that of the left-eye retardation plate 2LX to the light incident on the liquid crystal panel 10. In this manner, the phase difference of the liquid crystal panel 10 is switched between +λ/4 and −λ/4.

When a phase difference of the liquid crystal panel 10 is +λ/4, the light in which a phase difference of +λ/4 is given by the liquid crystal panel 10 to the image 20A emitted from the display panel 20 (specifically, to the right-eye image 20AR), and a phase difference of −λ/4 is given by the left-eye retardation plate 2LX is incident on the left eye UL of the viewer U. That is, the total change in the phase difference is represented by an expression of (+)/4)+(−λ/4)=0. Since the transmission axis 1PA and the left-eye transmission axis 2LPA are orthogonal to each other, the light from the display panel 20 (right-eye image 20AR) cannot pass through the left-eye polarizer 2LP, and the left-eye lens 2L becomes non-light-transmissive. On the other hand, the light in which a phase difference of +λ/4 is given by the liquid crystal panel 10 to the image 20A emitted from the display panel 20 (specifically, to the right-eye image 20AR), and a phase difference of +λ/4 is given by the right-eye retardation plate 2RX is incident on the right eye UR of the viewer U. That is, the total change in the phase difference is represented by an expression of (+λ/4)+(+)/4)=+\/2. Since the transmission axis 1PA and the right-eye transmission axis 2RPA are orthogonal to each other, the light from the display panel 20 (right-eye image 20AR) can pass through the right-eye polarizer 2RP, and the right-eye lens 2R becomes light-transmissive.

Similarly, when a phase difference of the liquid crystal panel 10 is −λ/4, the light in which a phase difference of −λ/4 is given by the liquid crystal panel 10 to the image 20A emitted from the display panel 20 (specifically, to the left-eye image 20AL), and a phase difference of −λ/4 is given by the left-eye retardation plate 2LX is incident on the left eye UL of the viewer U. That is, the total change in the phase difference is represented by an expression of (−λ/4)+(−>/4)=−λ/2. Since the transmission axis 1PA and the left-eye transmission axis 2LPA are orthogonal to each other, the light from the display panel 20 (left-eye image 20AL) can pass through the left-eye polarizer 2LP, and the left-eye lens 2L becomes light-transmissive. On the other hand, the light in which a phase difference of −λ/4 is given by the liquid crystal panel 10 to the image 20A emitted from the display panel 20 (specifically, to the left-eye image 20AL), and a phase difference of +λ/4 is given by the right-eye retardation plate 2RX is incident on the right eye UR of the viewer U. That is, the total change in the phase difference is represented by an expression of (−λ/4)+(+)/4)=0. Since the transmission axis 1PA and the right-eye transmission axis 2RPA are orthogonal to each other, the light from the display panel 20 (left-eye image 20AL) cannot pass through the right-eye polarizer 2RP, and the right-eye lens 2R becomes non-light-transmissive.

The display panel 20 may be a liquid crystal display panel including a liquid crystal layer and a color filter layer. In this case, the three-dimensional display device 1 is provided with a backlight 30 on the opposite side to the liquid crystal panel 10 of the display panel 20. The backlight 30 has a function of emitting backlight light 30A toward the display panel 20. The backlight 30 is provided on the opposite side to the viewer U of the display panel 20.

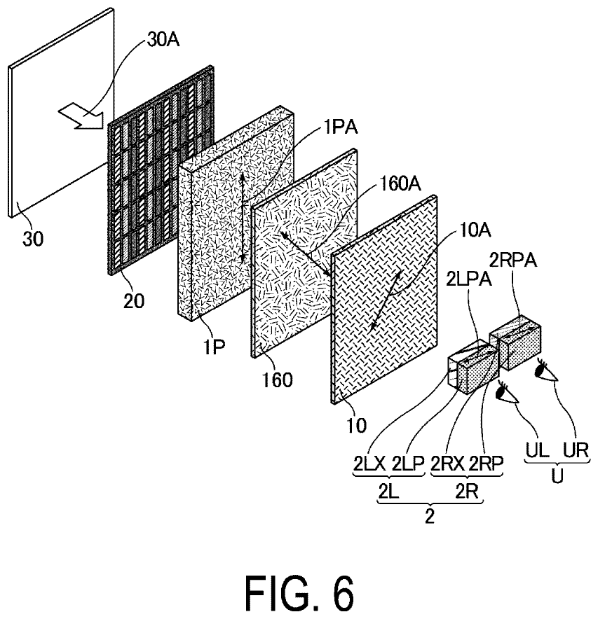

FIG. 6 is a schematic view illustrating an example of the three-dimensional display device according to the second embodiment. As illustrated in FIG. 6, the three-dimensional display device 1 according to the present embodiment may include a λ/4 retardation plate 160 between the polarizer 1P and the liquid crystal panel 10. The liquid crystal panel 10 can switch the phase difference between λ/2 and 0 nm, and the slow axis 10A of the liquid crystal panel 10 is orthogonal to a slow axis 160A of the λ/4 retardation plate 160. That is, the λ/4 retardation plate 160 gives a phase difference of −λ/4.

The slow axis of the liquid crystal panel is a slow axis of a liquid crystal layer included in the liquid crystal panel. The expression “a phase difference of the liquid crystal panel 10 is λ/2” means that a phase difference of the liquid crystal panel 10 is 225 nm or more and 325 nm or less, and preferably 240 nm or more and 310 nm or less. The expression “a phase difference of the liquid crystal panel 10 is 0 nm” means that a phase difference of the liquid crystal panel 10 is −30 nm or more and 30 nm or less, preferably −15 nm or more and 15 nm or less, and more preferably 0 nm.

For example, when a phase difference of the liquid crystal panel 10 in a voltage non-applied state is λ/2, the light emitted from the display panel 20 passes through the λ/4 retardation plate 160 and the liquid crystal panel 10 to be given a phase difference of λ/4. As a result, the left-eye lens 2L becomes non-light-transmissive while the right-eye lens 2R becomes light-transmissive. On the other hand, when a phase difference of the liquid crystal panel 10 in a voltage applied state is 0 nm, the light emitted from the display panel 20 passes through the λ/4 retardation plate 160 and the liquid crystal panel 10 to be given a phase difference of −λ/4. As a result, the left-eye lens 2L becomes light-transmissive while the right-eye lens 2R becomes non-light-transmissive.

More specifically, the liquid crystal panel 10 designed to have a phase difference of λ/2 in a state in which an applied voltage is Low (voltage non-applied state) has a slow axis in the x-axis direction. Thus, since a relation of nx>ny is established in the liquid crystal panel 10, a phase difference of the liquid crystal panel 10 is represented by an expression of (nx−ny)×thickness=+λ/2.

On the other hand, the λ/4 retardation plate 160 having a slow axis in the y-axis direction can also be said to be a λ/4 retardation plate having a fast axis in the x-axis direction. Thus, since a relation of nx<ny is established in the λ/4 retardation plate 160, a phase difference of the λ/4 retardation plate 160 is represented by an expression of (nx−ny)×thickness=−λ/4.

As described above, the total value of the phase differences of the liquid crystal panel 10 and the λ/4 retardation plate 160 in the voltage non-applied state is represented by an expression of (+)/2)+(−>/4)=+λ/4. Since the sign is +, the slow axis is parallel to the x-axis direction and the absolute value of the phase difference is λ/4.

The state in which the voltage applied to the liquid crystal panel 10 is Low has been described so far, but the phase difference of the liquid crystal panel 10 becomes 0 in a state in which the applied voltage is High (voltage applied state) (the phase difference does not become completely 0, but is assumed to be 0 here to simplify the description). Thus, the total value of the phase differences of the liquid crystal panel 10 and the λ/4 retardation plate 160 in the voltage applied state is represented by an expression of (0)+(−λ/4)=−λ/4. Since the sign is-, the slow axis is parallel to the y-axis direction and the absolute value of the phase difference is λ/4.

### First Modification Example of Second Embodiment

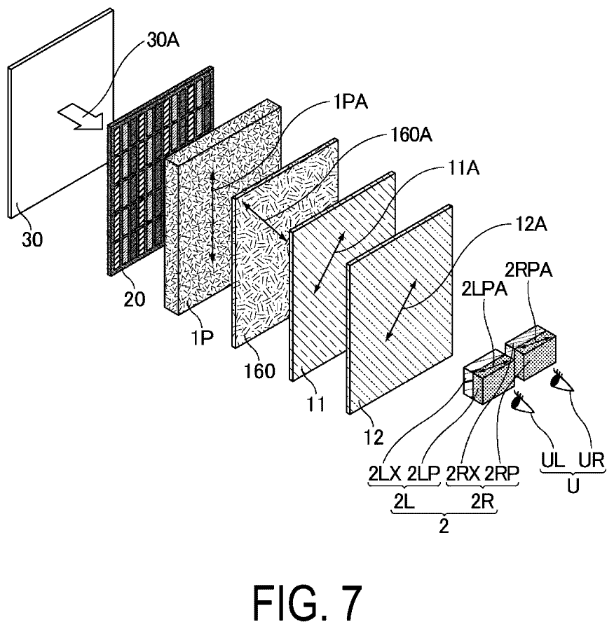

FIG. 7 is a schematic view illustrating an example of a three-dimensional display device according to a first modification example of the second embodiment. As illustrated in FIG. 7, a three-dimensional display device 1 of the present modification example includes the display panel 20, a polarizer 1P having a transmission axis 1PA, a first liquid crystal panel 11 as an active retarder, a second liquid crystal panel 12 as an active retarder, and the polarized glasses 2 in order toward the viewer U side. By adopting such a configuration, it is possible to achieve three-dimensional display while curbing white unevenness in the display region near the frame region, and vertical streak unevenness in the display region.

The three-dimensional display device 1 of the present modification example is the same as the three-dimensional display device 1 of the second embodiment except that the number of liquid crystal panels is different. That is, the three-dimensional display device 1 of the second embodiment includes one liquid crystal panel 10, and the liquid crystal panel 10 can switch the phase difference between λ/2 and 0 nm. On the other hand, the three-dimensional display device 1 of the present modification example includes two liquid crystal panels (the first liquid crystal panel 11 and the second liquid crystal panel 12), and each of the first liquid crystal panel 11 and the second liquid crystal panel 12 can switch the phase difference between λ/4 and 0 nm. In this manner, in the present modification example, the phase difference of the liquid crystal panel 10 in the second embodiment is divided by the two liquid crystal panels (the first liquid crystal panel 11 and the second liquid crystal panel 12).

The three-dimensional display device 1 of the present modification example may include the λ/4 retardation plate 160 between the polarizer 1P and the first liquid crystal panel 11. Each of the first liquid crystal panel 11 and the second liquid crystal panel 12 can switch the phase difference between λ/4 and 0 nm, a slow axis 11A of the first liquid crystal panel 11 is orthogonal to the slow axis 160A of the λ/4 retardation plate 160, and a slow axis 12A of the second liquid crystal panel 12 is orthogonal to the slow axis 160A of the λ/4 retardation plate 160. That is, the λ/4 retardation plate 160 gives a phase difference of −λ/4. The slow axis 10A of the liquid crystal panel 10 is a slow axis of the liquid crystal layer 130 included in the liquid crystal panel 10.

For example, when a phase difference of the first liquid crystal panel 11 in the voltage non-applied state is λ/4 and a phase difference of the second liquid crystal panel 12 in the voltage non-applied state is λ/4, the light emitted from the display panel 20 passes through the λ/4 retardation plate 160, the first liquid crystal panel 11, and the second liquid crystal panel 12 to be given a phase difference of λ/4. As a result, the left-eye lens 2L becomes non-light-transmissive while the right-eye lens 2R becomes light-transmissive. On the other hand, when a phase difference of the first liquid crystal panel 11 in the voltage applied state is 0 nm and a phase difference of the second liquid crystal panel 12 in the voltage applied state is 0 nm, the light emitted from the display panel 20 passes through the λ/4 retardation plate 160, the first liquid crystal panel 11, and the second liquid crystal panel 12 to be given a phase difference of −λ/4. As a result, the left-eye lens 2L becomes light-transmissive while the right-eye lens 2R becomes non-light-transmissive.

The effects of the disclosure will be described below with reference to the examples and comparative examples, but the disclosure is not limited by these examples.

### Example 1

The liquid crystal panel 10 corresponding to the above-described first embodiment was prepared. First, the first substrate 110 was prepared as follows. A cell thickness adjusting insulating protrusion (first substrate-side insulating protrusion 110X), the first transparent conductive film 112, and an insulating layer for preventing vertical leakage (first insulating layer 113) were formed on a glass substrate (first support substrate 111) having a thickness of 0.5 mm.

The material of the cell thickness adjusting insulating protrusion (first substrate-side insulating protrusion 110X) was a transparent organic film. Specifically, a truncated cone having a height of 300 nm was provided as a cell thickness adjusting insulating protrusion between the first support substrate 111 and the first transparent conductive film 112 at a position that is the same as the main spacer (spacer 120A) when the main surface of the substrate is viewed in a plan view, thereby forming the first substrate-side insulating protrusion 110X. That is, the height 110XH of the first substrate-side insulating protrusion 110X was 300 nm. The diameter of the upper surface of the truncated cone (the surface 110XT of the first substrate-side insulating protrusion 110X which faces the second substrate 120) was 20 μm, which was larger than the diameter of the top portion of the main spacer (the surface 120AT of the spacer 120A on the first substrate 110 side) included in the second substrate 120.

The material of the first transparent conductive film 112 was IZO and the thickness thereof was 70 nm. The material of the insulating layer for preventing vertical leakage (first insulating layer 113) was SiN, and the thickness thereof was 530 nm.

The screen size was a 27-type, and the effective display region was 581.8176 mm in the horizontal direction and 333.7992 mm in the vertical direction. The electrode structure was such that the transparent conductive film (first transparent conductive film 112) was divided into two segments at the center in the vertical direction.

The second substrate 120 was prepared in the following manner. A flat organic insulating layer of 920 nm was provided as a cell thickness adjusting insulating layer on a glass substrate having a thickness of 0.5 mm (second support substrate 121) to form the second substrate-side insulating layer 120X. Furthermore, the second transparent conductive film 122, an insulating layer for preventing vertical leakage (second insulating layer 123), and spacers (main spacer 120A and sub-spacer 120B) were formed on the second substrate-side insulating layer 120X.

The material of the second transparent conductive film 122 was IZO, and the thickness thereof was 140 nm. The material of the insulating layer for preventing vertical leakage (second insulating layer 123) was SiN, and the thickness thereof was 680 nm.

The spacer 120A serving as the main spacer had a cylindrical shape, the diameter of a bottom face of the spacer 120A (the surface 120AT of the spacer 120A on the first substrate 110 side and a surface on the second support substrate 121 side) was 15.3 μm, and the height 120AH was 1.32 μm. The sub-spacer 120B had a quadrangular prism shape, where the bottom face thereof had a length of 15 μm in the vertical direction and a length of 40 μm in the horizontal direction, and the height thereof was 1.32 μm. Each of the spacer 120A and the sub-spacer 120B was formed of a transparent organic film.

An alignment film material was applied on the surface of the first substrate 110 on the first insulating layer 113 side which was prepared as described above to form the first alignment film 151, and an alignment film material was applied on the surface of the second substrate 120 on the spacer 120A side to form the second alignment film 152. Thereafter, drawing was performed with a sealing resin in the frame region 10NA of the second substrate 120. Further, a liquid crystal material was dropped onto the first alignment film 151, and the first substrate 110 and the second substrate 120 were bonded together in such a manner that the first alignment film 151 and the second alignment film 152 face each other. Thereafter, the sealing resin was cured by performing UV exposure and heating to form the sealing portion 140. The thickness of the liquid crystal layer (cell thickness) was 1.62 μm.

The alignment film material included polyimide for horizontal alignment. The thicknesses of the first alignment film 151 and the second alignment film 152 were each 90 nm. The first alignment film 151 and the second alignment film 152 were subjected to anti-parallel rubbing treatment. The dielectric anisotropy of the liquid crystal material was positive, and An was 0.16.

A signal of the second substrate 120 is input from an input terminal for the upper substrate (first metal layer 114) included in the first substrate 110 through conductive beads for sealing included in the sealing portion 140. For this reason, the sealing resin contained conductive beads for sealing (diameter: 3 μm) for electrically connecting the first substrate 110 and the second substrate 120 and also contained a spacer for sealing (diameter: 2 μm) serving as a column of the sealing portion 140, and they were uniformly mixed. The finished height of the sealing resin, that is, the height of the sealing portion 140 was 2000 nm. The thicknesses of the first metal layer 114 and the second metal layer 124 were each 360 nm.

In the first example, the sum of the height 110XH (300 nm) of the first substrate-side insulating protrusion 110x and the height 120AH (1.32 μm) of the spacer 120A as the protrusion was equal to the thickness of the liquid crystal layer 130 (1.62 μm).

In a plan view, the entire surface 120AT of the spacer 120A facing the first substrate 110 was included inside the surface 110XT of the first substrate-side insulating protrusion 110X facing the second substrate 120.

### Comparative Example 1

The liquid crystal panel 10R according to the above-described comparative embodiment was prepared. Specifically, the liquid crystal panel 10R according to Comparative Example 1 was prepared in the same manner as in Example 1 except that the first substrate-side insulating protrusion 110X was not provided in the first substrate 110, the second substrate-side insulating layer 120X was not provided in the second substrate 120, and the height of the spacer 120AR as a main spacer was set to be 1.62 μm.

### Evaluation of White Unevenness of Liquid Crystal Panels According to Example 1 and Comparative Example 1

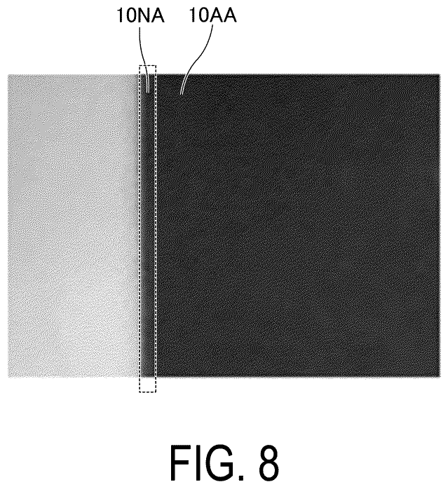

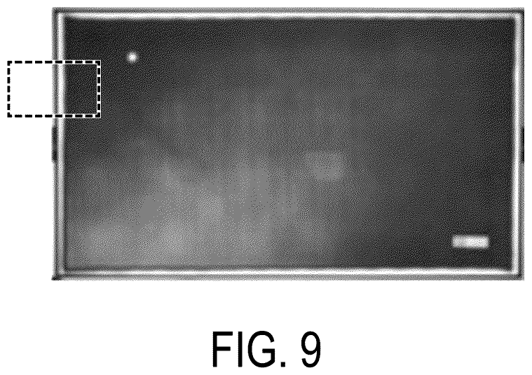

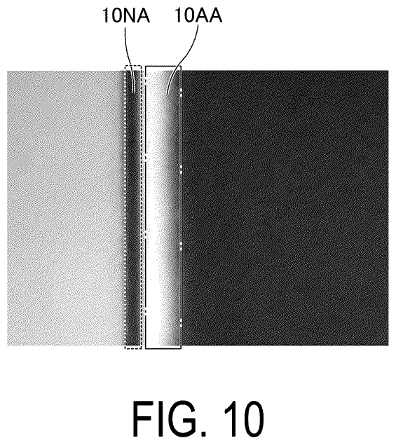

The liquid crystal panel 10 according to Example 1 and the liquid crystal panel 10R according to Comparative Example 1 were compared in a non-lighting black display state. FIG. 8 is a photograph illustrating a non-lighting black display state of the liquid crystal panel according to Example 1. FIG. 9 is a photograph illustrating a non-lighting black display state of the liquid crystal panel according to Comparative Example 1. FIG. 10 is an enlarged photograph of a region surrounded by a dashed line in FIG. 9.

As illustrated in FIG. 8, in the liquid crystal panel 10 according to Example 1, white unevenness in the display region 10AA near the frame region 10NA (sealing portion 140) was curbed. In the liquid crystal panel 10 according to Example 1, it is conceivable that, since the optimum cell thickness (1.62 μm) was obtained both in the vicinity of the sealing portion 140 and at the center of the cell, uniform black display could be achieved. The inside of a dashed line depicted in FIG. 8 is the frame region 10NA. Since the metal layer was disposed therein, light was not transmitted and the frame region 10NA became black.

On the other hand, in the liquid crystal panel 10R according to Comparative Example 1, as indicated by an alternating dotted-dashed line in FIG. 10, white unevenness occurred in the display region 10AA near the frame region 10NA (sealing portion 140). In the liquid crystal panel 10R according to Comparative Example 1, the optimum cell thickness at the cell center was 1.62 μm, whereas the cell thickness near the sealing portion 140 was approximately 2.0 μm. Thus, it is conceivable that the retardation near the sealing portion 140 was higher than the desired retardation and the white unevenness occurred. As described above, in the portion near the frame region 10NA according to Comparative Example 1, the retardation required for display performance of the 3D active retarder cannot be obtained, and thus, the portion mentioned above cannot be used for display. The inside of a dashed line depicted in FIG. 10 is the frame region 10NA. Since the metal layer was disposed therein, light was not transmitted and the frame region 10NA became black.

### Evaluation of Manufacturing Processes of Liquid Crystal Panels according to Example 1 and Comparative Example 1

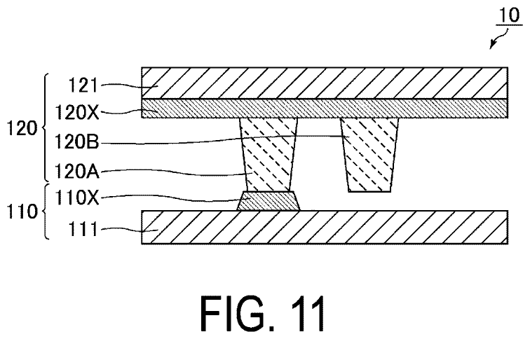

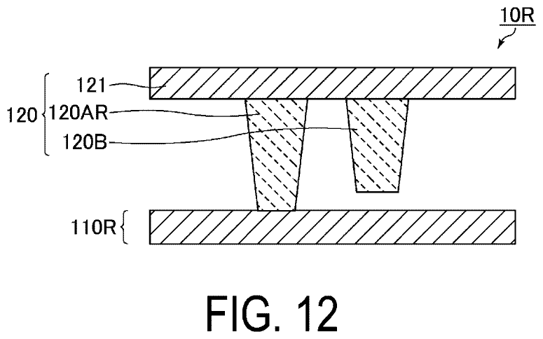

FIG. 11 is a schematic cross-sectional view illustrating a main spacer and a sub-spacer of the liquid crystal panel according to Example 1. FIG. 12 is a schematic cross-sectional view illustrating a main spacer and a sub-spacer of the liquid crystal panel according to Comparative Example 1. As illustrated in FIG. 11, in the liquid crystal panel 10 according to Example 1, since the height of the spacer 120A serving as a main spacer and the height of the sub-spacer 120B are the same, the main spacer and the sub-spacer can be collectively formed. On the other hand, in the liquid crystal panel 10R according to Comparative Example 1, as illustrated in FIG. 12, since the height of the spacer 120AR serving as a main spacer and the height of the sub-spacer 120B are different from each other, in order to form the spacer 120AR and the sub-spacer 120B, it is necessary to divide the process into two process stages of forming the spacer 120AR and forming the sub-spacer 120B, or to collectively form the spacer 120AR and the sub-spacer 120B by using half exposure.

In general liquid crystal panel applications, the height of the spacer is set to be 2.0 to 3.0 μm. On the other hand, in the liquid crystal panel 10R according to Comparative Example 1 used as an active retarder, the height of the spacer 120AR is set to be 1.62 μm and the height of the sub-spacer 120B is set to be 1.32 μm. The heights of the spacer 120AR and the sub-spacer 120B are lower than the heights of the spacers of general liquid crystal panels. For this reason, high accuracy is required for the process of forming the spacer 120AR and the sub-spacer 120B according to Comparative Example 1, and it is presumable that the process mentioned above is difficult to perform.

### Evaluation of Vertical Streak Unevenness of Liquid Crystal Panels According to Example 1 and Comparative Example 1

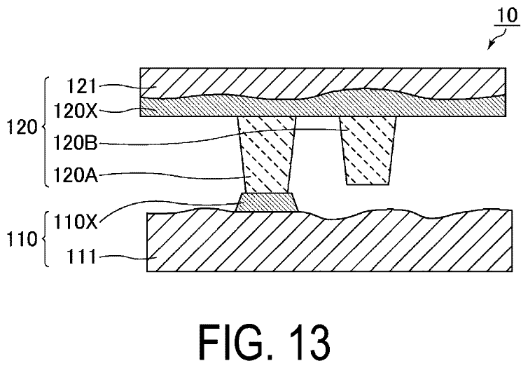

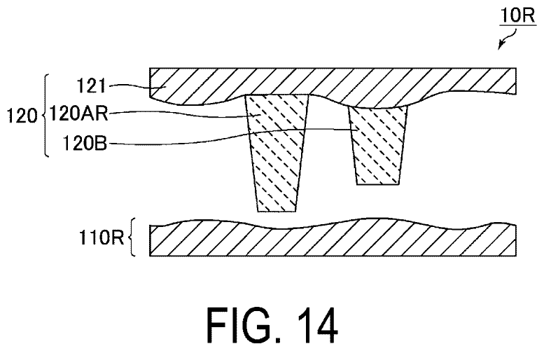

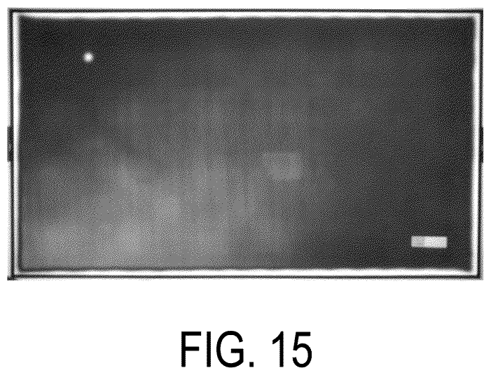

FIG. 13 is an example of a schematic cross-sectional view of the liquid crystal panel according to Example 1. FIG. 14 is an example of a schematic cross-sectional view of the liquid crystal panel according to Comparative Example 1. FIG. 15 is a photograph illustrating the vertical streak unevenness of the liquid crystal panel according to Comparative Example 1.

In the liquid crystal panel 10 according to Example 1, no vertical streak unevenness was observed. On the other hand, in the liquid crystal panel 10R according to Comparative Example 1, as illustrated in FIG. 15, vertical streak unevenness occurred at a pitch of approximately 20 to 30 mm in the display region 10AA.

As illustrated in FIGS. 13 and 14, although the first support substrate 111 and the second support substrate 121, which are glass substrates, are leveled with high accuracy in the glass manufacturing process, waviness with a height of 0.1 μm or less occurs at a pitch of 5 to 30 mm on the first support substrate 111 and the second support substrate 121.

In the liquid crystal panel 10R according to Comparative Example 1, as illustrated in FIG. 14, it is conceivable that the wavinesses of the glass substrates constituting the first support substrate 111 and the second support substrate 121 interfered with each other, then a difference in size of the cell thickness of the liquid crystal layer 130 was generated to cause a difference in retardation, and thus, the streak unevenness was visually recognized. That is, it is conceivable that the in-plane cell thickness became non-uniform due to the interference of the wavinesses of the glass substrates, and the streak unevenness of approximately 20 to 30 mm occurred and was visually recognized.

On the other hand, in the liquid crystal panel 10 according to Example 1, since the second substrate-side insulating layer 120X was provided on the second support substrate 121, as illustrated in FIG. 13, it is conceivable that the surface of the second substrate 120 was leveled to curb the interference of the wavinesses of the glass substrates, and thus, the streak unevenness was curbed.

### Evaluation of Pressing Against Liquid Crystal Panels According To Example 1 and Comparative Example 1

Even when the surface of the liquid crystal panel 10 according to Example 1 was pressed with a finger, light leakage was unlikely to occur. The liquid crystal panel 10 according to Example 1 includes the first substrate-side insulating protrusion 110X. For this reason, even when the surface of the liquid crystal panel 10 is pressed with a finger, the tip of the spacer 120A is unlikely to come into contact with a region of the display region 10AA where the first substrate-side insulating protrusion 110X is not disposed. As a result, it is conceivable that the first alignment film 151 was unlikely to be damaged, and thus, the light leakage due to the damage of the alignment film was unlikely to occur.

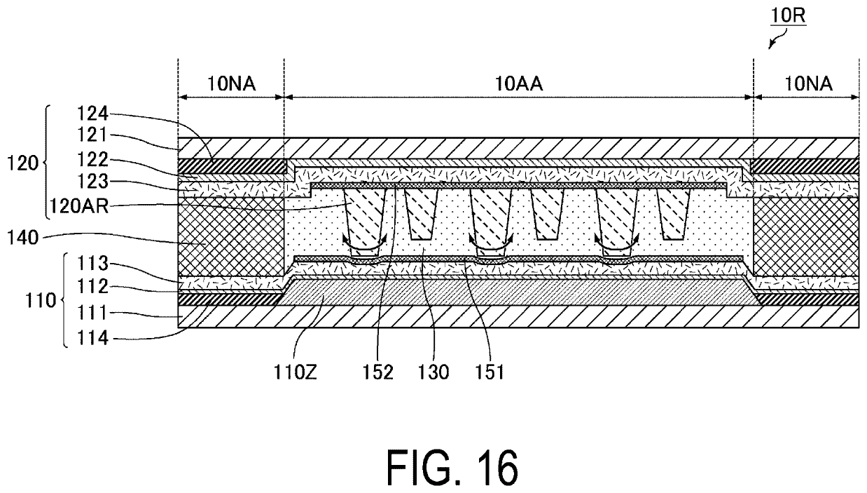

FIG. 16 is a schematic cross-sectional view illustrating a case in which the liquid crystal panel according to Comparative Example 1 is pressed. When the surface of the liquid crystal panel 10R according to Comparative Example 1 was pressed with a finger, a display defect (specifically, light leakage) occurred. It is conceivable that, when the surface of the liquid crystal panel 10R according to Comparative Example 1 was pressed with a finger, the spacer 120AR projected into the display region 10AA, the tip of the spacer 120AR scraped off the first alignment film 151 located in the display region 10AA, or the like, so that the liquid crystal molecules were not aligned as intended and the display defect occurred. In FIG. 16, a cell thickness adjusting insulating layer 110Z, which is not depicted in the liquid crystal panel 10R according to the comparative embodiment, is illustrated. The cell thickness adjusting insulating layer 110Z was a layer having a flat shape without irregularities.

### Example 2

The liquid crystal panel 10 according to the present example corresponds to the first modification example of the first embodiment. The first substrate 110 included in the liquid crystal panel 10 according to the present example is the same as the liquid crystal panel 10 according to Example 1 except that it includes the first substrate-side metal layer 115 which is in contact with the first support substrate 111 and is covered with the first substrate-side insulating protrusion 110X. In the liquid crystal panel 10 according to the present example, the first substrate-side metal layer 115 can function as a wiring line for reducing the resistance.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1. A liquid crystal panel comprising:
a display region;
a frame region disposed around the display region;
a first substrate; and
a second substrate disposed facing the first substrate,
wherein a liquid crystal layer is disposed between the first substrate and the second substrate in the display region,
a sealing portion is disposed between the first substrate and the second substrate in the frame region,
the second substrate is provided with a protrusion protruding toward a side of the liquid crystal layer, and the first substrate includes a first support substrate and a first substrate-side insulating protrusion in order toward the side of the liquid crystal layer, the first substrate-side insulating protrusion being in contact with the first support substrate, protruding toward the side of the liquid crystal layer, facing the protrusion, and being formed in an island shape.

2. The liquid crystal panel according to claim 1,
wherein the first substrate-side insulating protrusion has a truncated cone shape or a truncated pyramid shape.

3. The liquid crystal panel according to claim 1,
wherein a sum of a height of the first substrate-side insulating protrusion and a height of the protrusion is equal to a thickness of the liquid crystal layer.

4. The liquid crystal panel according to claim 1,
wherein, in a plan view, an entire surface of the protrusion facing the first substrate is included inside a surface of the first substrate-side insulating protrusion facing the second substrate.

5. The liquid crystal panel according to claim 1,
wherein, in the display region, the second substrate includes, in order toward the side of the liquid crystal layer, a second support substrate and a second substrate-side insulating layer in contact with the second support substrate.

6. The liquid crystal panel according to claim 5,
wherein the second substrate-side insulating layer has an end portion adjacent to the frame region, and
the end portion is inclined with respect to a main surface of the second support substrate.

7. The liquid crystal panel according to claim 1,
wherein the first substrate further includes a first transparent conductive film disposed on the side of the liquid crystal layer of the first substrate-side insulating protrusion, and a first insulating layer disposed on the side of the liquid crystal layer of the first transparent conductive film.

8. The liquid crystal panel according to claim 1,
wherein the second substrate includes a second support substrate, a second transparent conductive film disposed on the side of the liquid crystal layer of the second support substrate, and a second insulating layer disposed on the side of the liquid crystal layer of the second transparent conductive film.

9. The liquid crystal panel according to claim 8,
wherein, in the display region, the second substrate further includes a second substrate-side insulating layer being disposed between the second support substrate and the second transparent conductive film and being in contact with the second support substrate, and
in the frame region, the second substrate further includes a metal layer disposed between the second support substrate and the second transparent conductive film.

10. The liquid crystal panel according to claim 9,
wherein the metal layer is in contact with an end portion of the second substrate-side insulating layer.

11. The liquid crystal panel according to claim 9, wherein the second substrate-side insulating layer has an end portion adjacent to the frame region,
the end portion is inclined with respect to a main surface of the second support substrate, and
the metal layer is in contact with the end portion.

12. The liquid crystal panel according to claim 1,
wherein the first substrate further includes a first substrate-side metal layer being in contact with the first support substrate and at least partially overlapping the first substrate-side insulating protrusion in a plan view.

13. A three-dimensional display device comprising, in order toward a viewer side:
a display panel;
a polarizer having a transmission axis;
the liquid crystal panel according to claim 1 as an active retarder; and
polarized glasses.

14. The three-dimensional display device according to claim 13, further comprising:
a λ/4 retardation plate between the polarizer and the liquid crystal panel,
wherein the liquid crystal panel is configured to switch a phase difference between λ/2 and 0 nm, and
a slow axis of the liquid crystal panel is orthogonal to a slow axis of the λ/4 retardation plate.

15. A three-dimensional display device, comprising, in order toward a viewer side:
a display panel;
a polarizer having a transmission axis;
a first liquid crystal panel formed of the liquid crystal panel according to claim 1 as an active retarder;
a second liquid crystal panel formed of the liquid crystal panel according to claim 1 as an active retarder; and
polarized glasses.

16. The three-dimensional display device according to claim 15, further comprising:
a λ/4 retardation plate between the polarizer and the first liquid crystal panel,
wherein the first liquid crystal panel and the second liquid crystal panel are each configured to switch a phase difference between λ/4 and 0 nm,
a slow axis of the first liquid crystal panel is orthogonal to a slow axis of the λ/4 retardation plate, and
a slow axis of the second liquid crystal panel is orthogonal to the slow axis of the λ/4 retardation plate.
